(19) United States
(12) Patent Application Publication
(10) Pub. No.: US 2010/0259534 A1
(43) Pub. Date: Oct. 14, 2010

(54) PLASMA DISPLAY DEVICE

(76) Inventors: Mitsuhiro Murata, Hyogo (JP); Yasuhiro Arai, Osaka (JP); Toshikazu Wakabayashi, Osaka (JP); Hiroyasu Makino, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/744,383

(22) PCT Filed: Apr. 13, 2009
(86) PCT No.: PCT/JP2009/001685

§ 371 Date: May 24, 2010

(30) Foreign Application Priority Data
Apr. 18, 2008 (JP) 2008-108598

(51) Int. Cl. G09G 3/28; G09G 5/00

(52) U.S. Cl. 345/213; 345/60

(57) ABSTRACT

A plasma display device has a plasma display panel and a panel driving circuit for driving the panel. The panel driving circuit drives the panel in a manner that a period for causing an address discharge in all discharge cells is disposed in the address period, or before the address period of a subfield, and the subfield (first SF) is interposed at predetermined time intervals.

### TECHNICAL FIELD

The present invention relates to a plasma display device, which is an image display device using a plasma display panel.

### BACKGROUND ART

Among thin-type image display elements, a plasma display panel (hereinafter simply referred to as “panel”) allows high-speed display and can be easily upsized, and thus is commercialized as a large-screen image display device.

The panel is formed of a front plate and a back plate bonded together. The front plate has the following elements:

a glass substrate;

display electrode pairs, each formed of a scan electrode and a sustain electrode, disposed on the glass substrate;

a dielectric layer formed to cover the display electrode pairs; and

a protective layer formed on the dielectric layer.

The protective layer is disposed to protect the dielectric layer from ion collision and to facilitate discharge.

The back plate has the following elements:

a glass substrate;

data electrodes formed on the glass substrate;

a dielectric layer covering the data electrodes;

barrier ribs formed on the dielectric layer; and

phosphor layers formed between the barrier ribs and emitting light of red, green, and blue colors.

The front plate and the back plate face each other so that the display electrode pairs and the data electrodes intersect with each other with a discharge space sandwiched between the electrodes. The peripheries of the plates are sealed with a low-melting glass. A discharge gas containing xenon is sealed into the discharge space. Discharge cells are formed in parts where the display electrode pairs face the data electrodes.

In a plasma display device having a panel structured as above, a gas discharge is caused selectively in the respective discharge cells of the panel, and the ultraviolet light generated at this time excites the red, green, and blue phosphors so that light is emitted for color display. In this manner, the panel is basically similar to a fluorescent lamp in light emission principle, but has emission efficiency lower than that of the fluorescent lamp.

In recent years, a plasma display device having a large screen, high definition, and low power consumption has been demanded, and various efforts have been made to improve the emission efficiency of the panel. For example, Patent Literature 1 discloses the following technology: when the xenon content of the discharge gas is set in the range of 10 vol % or higher and lower than 100 vol %, and the pressure of the discharge gas is set in the range of 500 Torr to 760 Torr, both of which are higher than those of a conventional art, the emission efficiency of the ultraviolet light and the conversion efficiency in the phosphors are improved, and thus the luminance is improved.

One the other hand, increasing the xenon content of the discharge gas poses a problem: the time period after application of a voltage until generation of a discharge, i.e. a so-called discharge delay time, is increased, and thus driving the panel at high speed is difficult. As an effort to reduce the discharge delay time, Patent Literature 2, for example, discloses a panel that includes a magnesium oxide layer made from magnesium vapor by gas-phase oxidation and having a cathode luminescence emission peak at 200 nm to 300 nm.

A subfield method is typically used as a method for driving the panel. That is, one field period is divided into a plurality of subfields, and gradation display is provided by the combination of subfields in which light is emitted. Each subfield has an initializing period, an address period, and a sustain period. In the initializing period, predetermined voltages are applied to the scan electrodes and sustain electrodes, to cause an initializing discharge and to form wall charge necessary for the subsequent address operation on the respective electrodes. In the address period, a scan pulse is applied sequentially to the scan electrodes, and an address pulse is applied selectively to the data electrodes to cause an address discharge and to form wall charge. In the sustain period, sustain pulses are applied alternately to the display electrode pairs. Thereby, a sustain discharge is generated selectively in the discharge cells to cause the phosphor layers of the corresponding discharge cells to emit light. In this manner, an image is displayed.

In such panel driving methods, Patent Literature 3, for example, discloses a driving method for minimizing the light emission unrelated to gradation display and improving the contrast ratio by suppressing the emission luminance in the initializing discharge and limiting the number of initializing discharges caused in all the discharge cells.

However, when the xenon partial pressure is increased to improve the emission efficiency and luminance, and the number of initializing discharges caused in all the discharge cells is limited to improve the contrast, a new problem is posed. That is, a false discharge occurs in the initializing period and the image display quality is degraded.

[Patent Literature 1] Japanese Patent Unexamined Publication No. H10-125237

[Patent Literature 2] Japanese Patent Unexamined Publication No. 2006-054158

[Patent Literature 3] Japanese Patent Unexamined Publication No. 2000-242224]

### SUMMARY OF THE INVENTION

A plasma display device has a panel and a panel driving circuit. The panel has a front plate and a back plate facing each other. The front plate has display electrode pairs formed on a first glass substrate, a dielectric layer formed to cover the display electrode pairs, and a protective layer formed on the dielectric layer. The back plate has data electrodes formed on a second glass substrate. Discharge cells are formed in positions where the display electrode pairs face the data electrodes. The panel driving circuit drives the panel in a manner that a plurality of subfields are temporally disposed to form one field period. Each of the subfields has an initializing period for causing an initializing discharge, an address period for causing an address discharge, and a sustain period for causing a sustain discharge, in the discharge cells. The panel driving circuit drives the panel in a manner that the subfields include a subfield where a period for causing an address discharge in all the discharge cells is disposed in the address period, or before the initializing period and

the address period, and the subfield is interposed at predetermined time intervals.

### BRIEF DESCRIPTION OF DRAWINGS

FIG. 1 is an exploded perspective view showing a structure of a panel in accordance with an exemplary embodiment of the present invention.

FIG. 2 is a graph showing the relation between a xenon partial pressure and an emission luminance.

FIG. 3 is a sectional view showing a structure of a front plate of the panel in accordance with the exemplary embodiment.

FIG. 4 is a diagram showing an emission spectrum of a single-crystal particle for use in the panel.

FIG. 5 is a graph showing the relation between a peak ratio of an emission spectrum of the single-crystal particle for use in the panel and a discharge delay time.

FIG. 6 is a sectional view showing another structure of the front plate of the panel.

FIG. 7 is a diagram showing an electrode array of the panel.

FIG. 8 is a waveform chart of driving voltages to be applied to the respective electrodes of the panel for image display.

FIG. 9 is a waveform chart of driving voltages to be applied to the respective electrodes of the panel for surplus charge erasing operation.

FIG. 10 is a waveform chart of driving voltages to be applied to the respective electrodes of the panel for surplus charge erasing operation in accordance with another exemplary embodiment of the present invention.

FIG. 11 is a circuit block diagram of a plasma display device in accordance with the exemplary embodiment of the present invention.

FIG. 12 shows a scan electrode driving circuit and a sustain electrode of the plasma display device.

### REFERENCE MARKS IN THE DRAWINGS

10 Panel
20 Front plate
21 (First) glass substrate
22 Scan electrode
22a, 23a Transparent electrode
22b, 23b Bus electrode
23 Sustain electrode
24 Display electrode pair
25 Dielectric layer
26 Protective layer
26a Base protective layer
26b Particle layer
27 Single-crystal particle
30 Back plate
31 (Second) glass substrate
32 Data electrode
34 Barrier rib
35 Phosphor layer
41 Image signal processing circuit
42 Data electrode driving circuit
43 Scan electrode driving circuit
44 Sustain electrode driving circuit
45 Timing generating circuit
50, 80 Sustain pulse generating circuit
60 Initializing waveform generating circuit
70 Scan pulse generating circuit
100 Plasma display device

### DETAILED DESCRIPTION OF PREFERRED EMBODIMENT

A plasma display device in accordance with an exemplary embodiment of the present invention is demonstrated hereinafter with reference to the accompanying drawings.

### Exemplary Embodiment

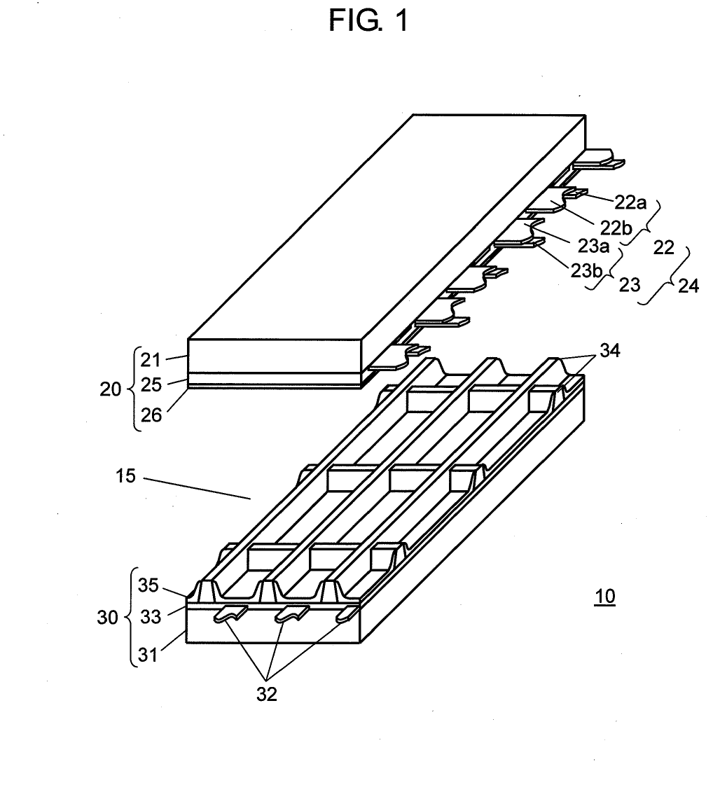

FIG. 1 is an exploded perspective view showing a structure of a panel in accordance with the exemplary embodiment of the present invention. In panel 10, front plate 20 and back plate 30 face each other, and the outer peripheries of the plates are sealed with a sealing material of a low-melting glass. A discharge gas containing xenon is sealed into discharge space 15 inside of panel 10.

A plurality of display electrode pairs 24, each formed of scan electrode 22 and sustain electrode 23, are disposed parallel to each other on glass substrate (first glass substrate) 21 of front plate 20. Each scan electrode 22 is formed of transparent electrode 22a composed of indium tin oxide, tin oxide, or the like, and bus electrode 22b disposed on transparent electrode 22a. Similarly, each sustain electrode 23 is formed of transparent electrode 23a, and bus electrode 23b disposed on the transparent electrode. Bus electrodes 22b and bus electrodes 23b are disposed to impart conductivity in the longitudinal direction of respective transparent electrodes 22a and transparent electrodes 23a, and are formed of a conductive material predominantly composed of silver. On glass substrate 21, dielectric layer 25 is formed so as to cover display electrode pairs 24. Further, protective layer 26 predominantly composed of magnesium oxide is formed on dielectric layer 25. Dielectric layer 25 is formed by applying a low-melting glass predominantly composed of lead oxide, bismuth oxide, or phosphorus oxide, for example, by screen printing, die coating, or other methods, and firing the glass.

A plurality of data electrodes 32 are disposed parallel to each other on glass substrate (second glass substrate) 31 of back plate 30 in the direction orthogonal to display electrode pairs 24. Dielectric layer 33 covers the data electrodes. Further, barrier ribs 34 are formed on dielectric layer 33. Phosphor layers 35, each caused to emit red, green, or blue light by ultraviolet light, are formed on dielectric layer 33 and the side faces of barrier ribs 34. A discharge cell is formed in a position where display electrode pair 24 intersects with data electrode 32. A set of discharge cells having red, green, and blue phosphor layers 35 forms a pixel for color display. Dielectric layer 33 is not essential, and may be omitted from the structure of the panel.

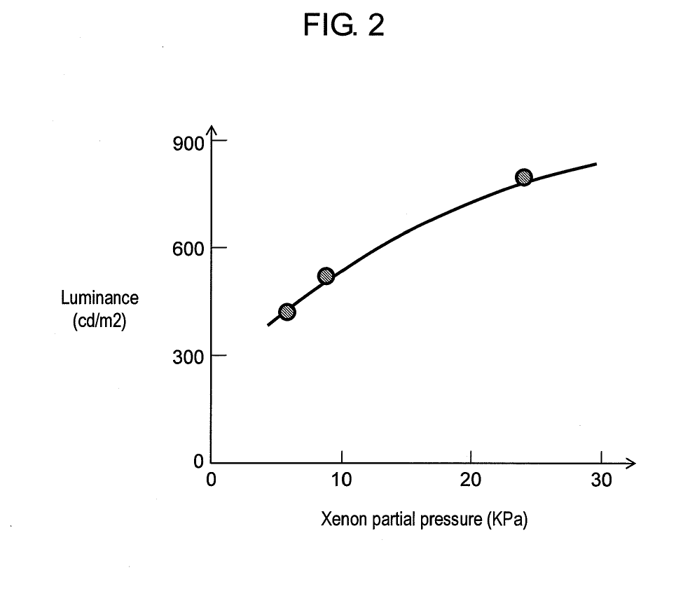

In the exemplary embodiment, a mixed gas of neon and xenon is used as a discharge gas. In order to improve the emission efficiency and luminance, the xenon partial pressure is set to 24 kPa. FIG. 2 is a graph showing the relation between a xenon partial pressure and an emission luminance. Trial panels, each having a xenon partial pressure of 6 kPa, 9 kPa, or 24 kPa, are fabricated and the luminance is compared between these trial panels driven under the same driving conditions. As a result, the emission luminance of a panel having a xenon partial pressure of 24 kPa is approximately twice the luminance of a conventional panel having a xenon partial pressure of 6 kPa. This shows that the emission efficiency is approximately twice. In the exemplary embodiment, in order to provide the emission efficiency approximately twice that of the conventional panel, the xenon partial pressure is set to 24 kPa.

However, as described above, increasing the xenon partial pressure poses a problem: the emission efficiency is increased but the discharge delay time is increased, and thus high-speed driving is difficult. In the exemplary embodiment, protective layer 26 of panel is devised to reduce the discharge delay and allow high-speed driving.

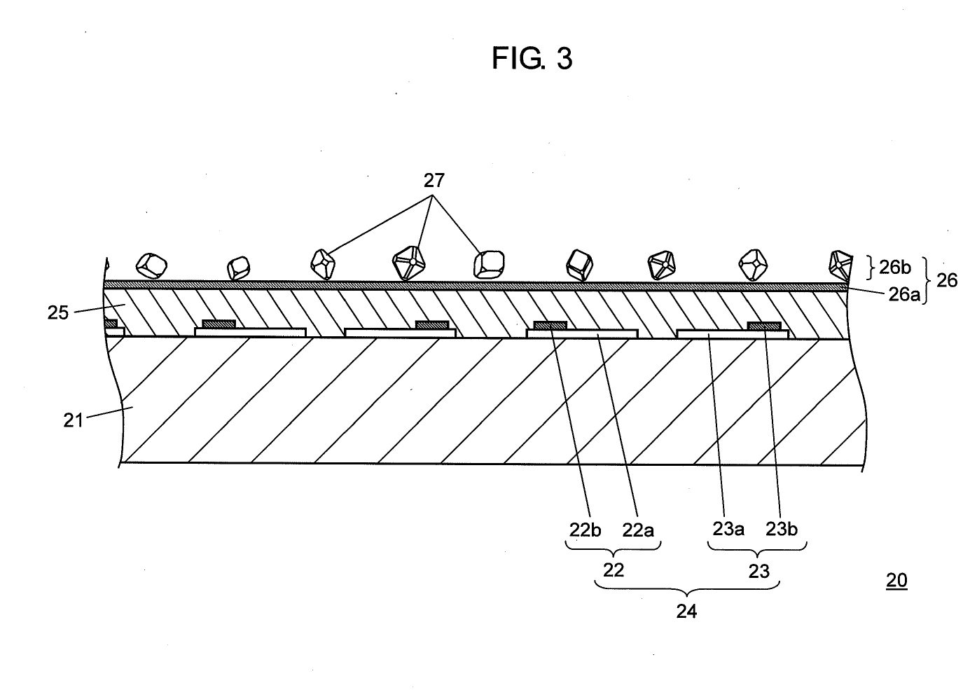

FIG. 3 is a sectional view showing a structure of front plate 20 of panel 10 in accordance with the exemplary embodiment of the present invention. FIG. 3 illustrates front plate 20 of FIG. 1 vertically inverted. Display electrode pairs 24, each formed of scan electrode 22 and sustain electrode 23, are formed on glass substrate 21. Dielectric layer 25 is formed to cover the display electrodes.

On dielectric layer 25, protective layer 26 is formed. Protective layer 26 is detailed hereinafter. In order to protect dielectric layer 25 from ion collision, and improve electron emission performance and charge retention performance that have considerable influence on driving speed, protective layer 26 has base protective layer 26a formed on dielectric layer 25, and particle layer 26b formed on base protective layer 26a.

Base protective layer 26a is a thin film layer of magnesium oxide that has a thickness of 0.3 μm to 1 μm and is formed by sputtering, ion plating, electron beam evaporation, or other methods.

Particle layer 26b is formed by attaching, to base protective layer 26a, single-crystal particles 27 of magnesium oxide that are made by firing a magnesium oxide precursor and have a relatively uniform particle-size distribution with an average particle diameter of 0.3 μm to 4 μm. In FIG. 3, single-crystal particles 27 are shown in an enlarged state. Single-crystal particles 27 do not need to cover the entire surface of base protective layer 26a, and only need to be formed in an island shape having a covering ratio of 1% to 30% on base protective layer 26a. Single-crystal particles 27 are basically shaped into a regular hexahedron or a regular octahedron. However, slight deformation caused by variations in production is allowed. The single-crystal particles may be shaped to have an NaCl crystal structure that includes truncated faces and rhombic faces formed by cutting vertexes and ridge lines, respectively, in the regular hexahedron or regular octahedron, and is surrounded by specified two type orientation faces of a (100) face and a (111) face, or specified three type orientation faces of a (100) face, a (110) face, and a (111) face.

In this manner, protective layer 26 is made of base protective layer 26a, and particle layer 26b formed on base protective layer 26a. With this structure, panel 10 that has protective layer 26 exhibiting both high electron emission performance and charge retention performance can be provided.

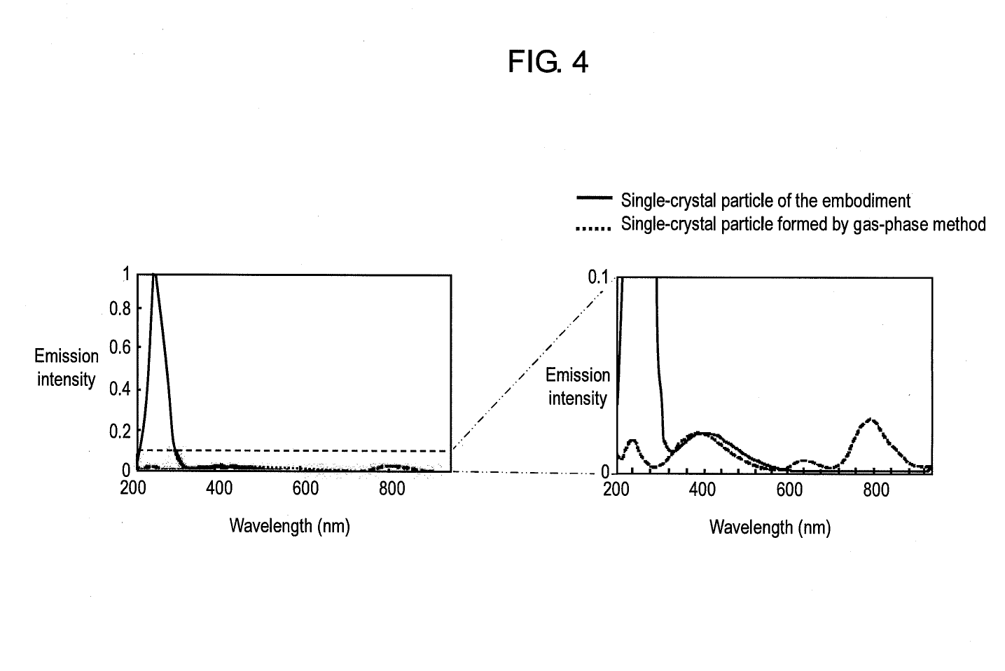

Examining cathode luminescence light emission of a single-crystal particle, the inventors have found that the characteristics, particularly electron emission performance, of the single-crystal particle can be evaluated from an emission spectrum thereof. FIG. 4 is a diagram showing an emission spectrum of single-crystal particle 27 for use in the panel in accordance with the exemplary embodiment of the present invention. For comparison, FIG. 4 also shows an emission spectrum of a single-crystal particle of magnesium oxide formed on the base protective layer by a gas-phase oxidation method. The emission spectrum of single-crystal particle 27 of the exemplary embodiment has a large peak of emission intensity at 200 nm to 300 nm, and a small peak at 300 nm to 550 nm. On the other hand, in the emission spectrum of the single-crystal particle formed by the gas-phase oxidation method, the peak of emission intensity at 200 nm to 300 nm and the peak of emission intensity at 300 nm to 550 nm are both small.

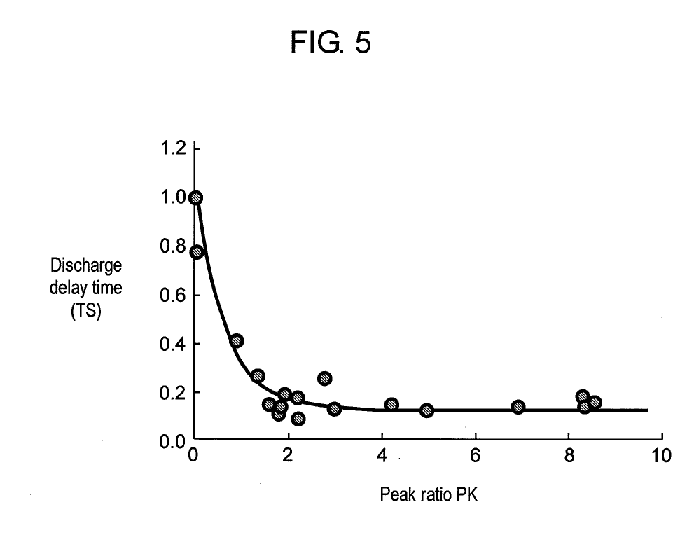

Focusing on the emission intensity of these two peaks, the inventors have examined the relation between electron emission performance and the ratio of the emission intensity of a peak at 200 nm to 300 nm to the emission intensity of a peak at 300 nm to 550 nm (hereinafter simply referred to as “peak ratio PK”). For this purpose, the inventors have fabricated trial panels having different values of peak ratio PK and measured a discharge delay time for each panel. FIG. 5 is a graph showing the relation between peak ratio PK of an emission spectrum of single-crystal particle 27 for use in the panel of the exemplary embodiment and discharge delay time Td. The horizontal axis represents peak ratio PK, which is determined by calculating a ratio of the integration value of an emission spectrum in the range of 200 nm or larger and smaller than 300 nm and the integration value of the emission spectrum in the range of 300 nm or larger and smaller than 550 nm. The vertical axis represents a discharge delay time, as value TS, which is a normalized value with respect to the discharge delay time exhibited when peak ratio PK is approximately zero. That is, a panel exhibiting smaller value TS has higher electron emission performance. As shown in the graph, when peak ratio PK of the emission spectrum is at least two, i.e. when the emission intensity of a peak at 200 nm to 300 nm is at least twice the emission intensity of a peak at 300 nm to 550 nm in the emission spectrum of cathode luminescence light emission, normalized discharge delay time TS is kept substantially constant at 0.2 or smaller, which shows excellent electron emission performance.

The above single-crystal particles 27 can be produced by a liquid phase method.]

Specifically, for example, a small amount of acid is added to an aqueous solution of magnesium alkoxide or magnesium acetylacetone at a purity of 99.95% or higher. Thereby, the solution is hydrolyzed, so that a gel of magnesium hydroxide is prepared. The gel is fired in the air for dehydration. Thus the powder of single-crystal particles 27 is produced.

Preferably, the firing temperature is set in the range of 700° C. to 1800° C. for the following reasons: the crystal faces grow insufficiently and have many defects at temperatures lower than 700° C., and oxygen deficiency increases defects in the magnesium oxide crystal at excessively high firing temperatures.

In this manner, particle layer 26b of the exemplary embodiment is formed by attaching, to base protective layer 26a, single-crystal particles 27 such that ratio K of a peak at 200 nm to 300 nm to a peak at 300 nm to 550 nm in the emission spectrum is at least two. This structure allows panel 10 to have both stably high electron emission performance and charge retention performance, and to be driven at high speed.

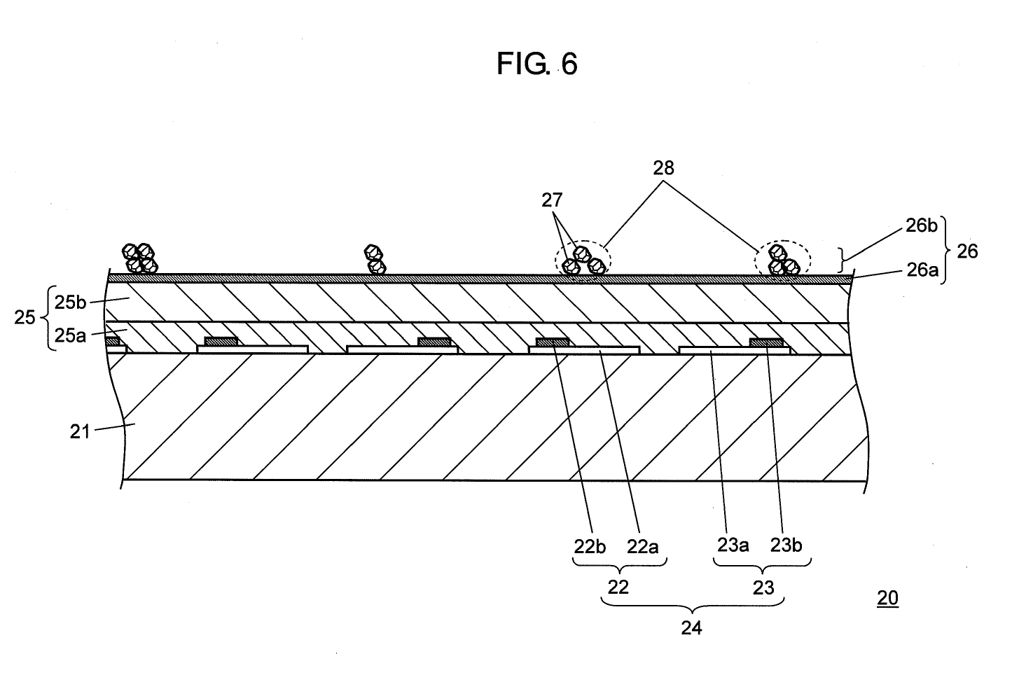

The structure of particle layer 26b is not limited to the above. Other structures may be used as long as protective layer 26 having both high electron emission performance and charge retention performance can be obtained. FIG. 6 is a sectional view showing another structure of front plate 2 of panel 10 in accordance with the exemplary embodiment of the present invention, and shows the structure of another particle layer 26b. Particle layer 26b of FIG. 6 is formed by discretely attaching agglomerated particles 28 in which a plurality of single-crystal particles 27 of magnesium oxide are agglomerated so that the agglomerated particles are substantially uniformly distributed across the entire surface of base protective layer 26a. In FIG. 6, agglomerated particles 28 are shown in an enlarged state. Agglomerated particle 28 is in a state where single-crystal particles 27 are agglomerated or necked in this manner. The plurality of single-crystal particles 27 are formed into an aggregate by static electricity, van der Waals force, or the like. Preferably, each single-crystal particle 27 is shaped into a polyhedron having at least seven faces, such as a tetradecahedron and dodecahedron, and has a particle diameter of approximately 0.9 μm to 2.0 μm. Preferably, in agglomerated particle 28, two to five single-crystal particles 27 are agglomerated. Preferably, each agglomerated particle 28 has a particle diameter of approximately 0.3 μm to 5 μm. Such a structure also allows panel 10 to have both stably high electron emission performance and charge retention performance, and to be driven at high speed.

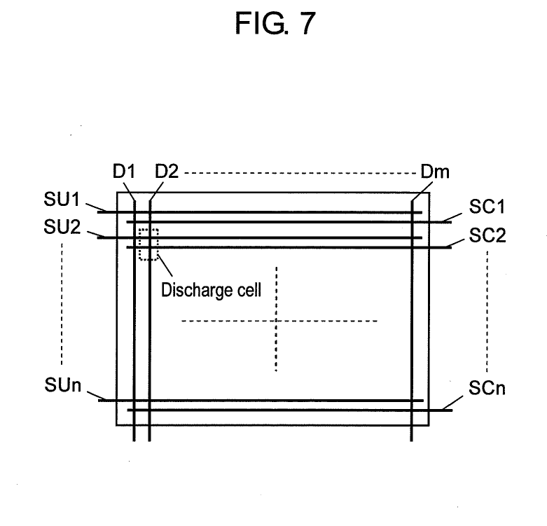

FIG. 7 is a diagram showing an electrode array of panel 10 in accordance with the exemplary embodiment of the present invention. Panel 10 has n scan electrodes SC1 through SCn (scan electrodes 22 in FIG. 1) and n sustain electrodes SU1 through SUn (sustain electrodes 23 in FIG. 1) both long in the row (line) direction, and m data electrodes D1 through Dm (data electrodes 32 in FIG. 1) long in the column direction. A discharge cell is formed in the part where a pair of scan electrode SCi (i being 1 through n) and sustain electrode SUi intersects with one data electrode Dj (j being 1 through m). Thus m×n discharge cells are formed in the discharge space. For example, the number of discharge cells in a panel for use in a high-definition plasma display device is represented by the following values: m=1920×3=5760, and n=1080

Next, a description is provided for a method for driving panel 10 in accordance with the exemplary embodiment of the present invention. Panel 10 is driven by a subfield method in which a plurality of subfields are temporally disposed to form one field period. That is, one field period is divided into a plurality of subfields, and light emission and no light emission of each discharge cell are controlled in each subfield for gradation display. Each subfield has an initializing period, an address period, and a sustain period.

In the initializing periods, an initializing discharge is caused to form wall charge necessary for the subsequent address discharge on the respective electrodes. The initializing operations at this time include the following two types: an initializing operation for causing an initializing discharge in all the discharge cells (hereinafter simply referred to as “all-cell initializing operation”), and an initializing operation for causing an initializing discharge in the discharge cells having undergone a sustain discharge in the sustain period of the immediately preceding subfield (hereinafter “selective initializing operation”). In the address periods, an address discharge is caused selectively in the discharge cells to be lit, so that wall charge is formed in the cells. In the sustain periods, numbers of sustain pulses predetermined for the respective subfields are applied alternately to the display electrode pairs. Thereby, a sustain discharge is caused for light emission in the discharge cells having undergone the address discharge.

In the exemplary embodiment, a description is provided for the following case. One field is divided into 10 subfields (the first subfield (SF), and the second SF to the 10th SF). Further, 1, 2, 3, 6, 11, 18, 30, 44, 60, and 80 sustain pulses are applied to the display electrode pairs in the sustain periods of the corresponding subfields in this order. The first SF is a subfield where an all-cell initializing operation is performed. Each of the second SF through the 10th SF is a subfield where a selective initializing operation is performed. However, the subfield structure, including the number of subfields and the number of sustain pulses, is not limited to the above. Preferably, the subfield structure is set optimum for the characteristics of the panel, the specifications of the plasma display device, or the like, for each case.

In the exemplary embodiment, in order to suppress a false discharge in the initializing periods, the operation for causing an address discharge in all the discharge cells (hereinafter simply referred to as “surplus charge erasing operation”) is performed at predetermined time intervals. The surplus charge erasing operation will be detailed later. First, a description is provided for driving voltage waveforms to be applied to the respective electrodes for image display and the operation of the panel.

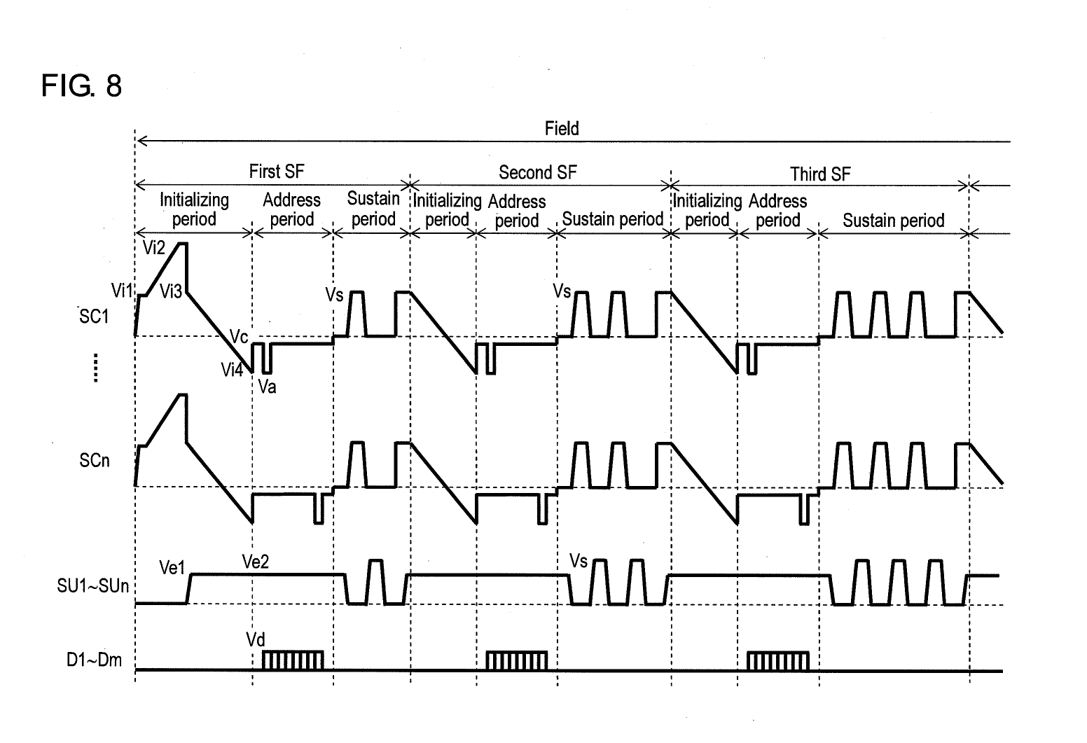

FIG. 8 is a waveform chart of driving voltages to be applied to the respective electrodes of panel 10 for image display in accordance with the exemplary embodiment of the present invention. The waveform chart shows driving voltages in the first SF through the third SF.

In the first half of the initializing period of the first SF, 0 (V) is applied to each of data electrodes D1 through Dm and sustain electrodes SU1 through SUn, and a ramp waveform voltage is applied to scan electrodes SC1 through SCn. Here, the ramp waveform voltage gradually rises from voltage Vi1, which is equal to or lower than a discharge start voltage, toward voltage Vi2, which exceeds the discharge start voltage, with respect to sustain electrodes SU1 through SUn.

While this ramp waveform voltage is rising, a weak initializing discharge occurs between scan electrodes SC1 through SCn and sustain electrodes SU1 through SUn, and between the scan electrodes and data electrodes D1 through Dm. Then, negative wall voltage accumulates on scan electrodes SC1 through SCn. Positive wall voltage accumulates on data electrodes D1 through Dm and sustain electrodes SU1 through SUn. Here, the wall voltages on the electrodes represent the voltages that are generated by wall charge accumulated on the dielectric layers covering the electrodes, the protective layer, and the phosphor layers, or the like. In this initializing discharge, wall voltages are excessively accumulated prior to the subsequent latter half of the initializing period in which the wall voltages are optimized.

Next, in the latter half of the initializing period, voltage Ve1 is applied to sustain electrodes SU1 through SUn, and a ramp waveform voltage is applied to scan electrodes SC1 through SCn. Here, the ramp waveform voltage gradually falls from voltage V13, which is equal to or lower than the discharge start voltage, toward voltage V14, which exceeds the discharge start voltage, with respect to sustain electrodes SU1 through SUn. During this application, a weak initializing discharge occurs between scan electrodes SC1 through SCn and sustain electrodes SU1 through SUn, and between the scan electrodes and data electrodes D1 through Dm. This weak discharge reduces the negative wall voltage on scan electrodes SC1 through SCn, and the positive wall voltage on sustain electrodes SU1 through SUn, and adjusts the positive wall voltage on data electrodes D1 through Dm to a value appropriate for the address operation. In this manner, the all-cell initializing operation for causing the initializing discharge in all the discharge cells is completed.

In the subsequent address period, voltage Ve2 is applied to sustain electrodes SU1 through SUn, and voltage Vc is applied to scan electrodes SC1 through SCn.

Next, negative scan pulse voltage Va is applied to scan electrode SC1 in the first line. Positive address pulse voltage Vd is applied to data electrode Dk (k being 1 through m) of a discharge cell to be lit in the first line, among data electrodes D1 through Dm. At this time, the voltage difference in the intersecting part between data electrode Dk and scan electrode SC1 is obtained by adding the difference in an externally applied voltage (Vd−Va) to the difference between the wall voltage on data electrode Dk and the wall voltage on scan electrode SC1. Thus the voltage difference exceeds the discharge start voltage. Then, an address discharge occurs between data electrode Dk and scan electrode SC1, and between sustain electrode SU1 and scan electrode SC1. Positive wall voltage accumulates on scan electrode SC1 and negative wall voltage accumulates on sustain electrode SU1. Negative wall voltage also accumulates on data electrode Dk.

The time after application of scan pulse voltage Va and address pulse voltage Vd until generation of an address discharge is a discharge delay time with respect to the address discharge. If a panel has low electron emission performance and thus a long discharge delay time, the time period during which scan pulse voltage Va and address pulse voltage Vd are applied for a reliable address operation, i.e. a scan pulse width and an address pulse width, need to be set longer. Thus the address operation cannot be performed at high speed. If a panel has low charge retention performance, the values of scan pulse voltage Va and address pulse voltage Vd need to be set higher in order to compensate for a decrease in the wall voltages. However, because panel 10 of the exemplary embodiment has high electron emission performance, the scan pulse width and address pulse width can be set shorter than those of the conventional panel and the address operation can be performed stably at high speed. Further, because panel 10 of the exemplary embodiment has high charge retention performance, the values of scan pulse voltage Va and address pulse voltage Vd can be set lower than those of the conventional panel.

In this manner, the address operation is performed to cause the address discharge in the discharge cells to be lit in the first line and to accumulate wall voltages on the corresponding electrodes. On the other hand, the voltage in the intersecting parts between data electrodes D1 through Dm applied with no address pulse voltage Vd and scan electrode SC1 does not exceed the discharge start voltage, so that no address discharge occurs. The above address operation is repeated until the operation reaches the discharge cells in the n-th line, and the address period is completed.

In the subsequent sustain period, first, positive sustain pulse voltage Vs is applied to scan electrodes SC1 through SCn, and 0 (V) is applied to sustain electrodes SU1 through SUn. Then, in the discharge cells having undergone the address discharge, the voltage difference between scan electrode SCi and sustain electrode SUi is obtained by adding sustain pulse voltage Vs to the difference between the wall voltage on scan electrode SCi and the wall voltage on sustain electrode SUi. Thus the voltage difference exceeds the discharge start voltage.

Then, a sustain discharge occurs between scan electrode SCi and sustain electrode SUi, and ultraviolet light generated at this time causes phosphor layers 35 to emit light. Negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and the wall voltage at the completion of the initializing period is maintained.

Subsequently, 0 (V) is applied to scan electrodes SC1 through SCn, and sustain pulse voltage Vs is applied to sustain electrodes SU1 through SUn. In the discharge cell having undergone the sustain discharge, the voltage difference between sustain electrode SUi and scan electrode SCi exceeds the discharge start voltage. Then, a sustain discharge occurs between sustain electrode SUi and scan electrode SCi again. Negative wall voltage accumulates on sustain electrode SUi, and positive wall voltage accumulates on scan electrode SCi.

In this manner, a predetermined number of sustain pulses are applied alternately to scan electrodes SC1 through SCn and sustain electrodes SU1 through SUn to cause a potential difference between the electrodes of each display electrode pair. Thereby, the sustain discharge is continued in the discharge cells having undergone the address discharge in the address period.

At the end of the sustain period, a potential difference in the form of a so-called narrow pulse is caused between scan electrodes SC1 through SCn and sustain electrodes SU1 through SUn. Thereby, while the positive wall voltage is left on data electrode Dk, the wall voltages on scan electrode SCi and sustain electrode SUi are erased. Instead of the potential difference in the form of a so-called narrow pulse, a potential difference in a ramp waveform may be caused to erase the wall voltages on scan electrode SCi and sustain electrode SUi while the positive wall voltage is left on data electrode Dk.

In the initializing period of the second SF, voltage Ve1 is applied to sustain electrodes SU1 through SUn, 0 (V) is applied to data electrodes D1 through Dm, and a ramp voltage gradually falling toward voltage V14 is applied to scan electrodes SC1 through SCn. In the discharge cells having undergone a sustain discharge in the sustain period of the preceding subfield, a weak initializing discharge occurs and reduces the wall voltages on scan electrode SCi and sustain electrode SUi. On data electrode Dk, the sufficient positive wall voltage is accumulated by the immediately preceding sustain discharge. Thus the excess part of the wall voltage is discharged, and the wall voltage is adjusted to a value appropriate for the address operation.

On the other hand, in the discharge cells having undergone no sustain discharge in the preceding subfield, no discharge occurs, and the wall charge at the completion of the initializing period of the preceding subfield is maintained. In this manner, in the selective initializing operation, an initializing discharge is caused selectively in the discharge cells having undergone a sustain operation in the sustain period of the immediately preceding subfield.

The operation in the subsequent address period is similar to the operation in the address period of the first SF, and the description is omitted. The operation in the sustain period is similar to that in the sustain period of the first SF, except for the number of sustain pulses. The operations in the subsequent third SF through 10th SF are similar to that in the second SF, except for the numbers of sustain pulses.

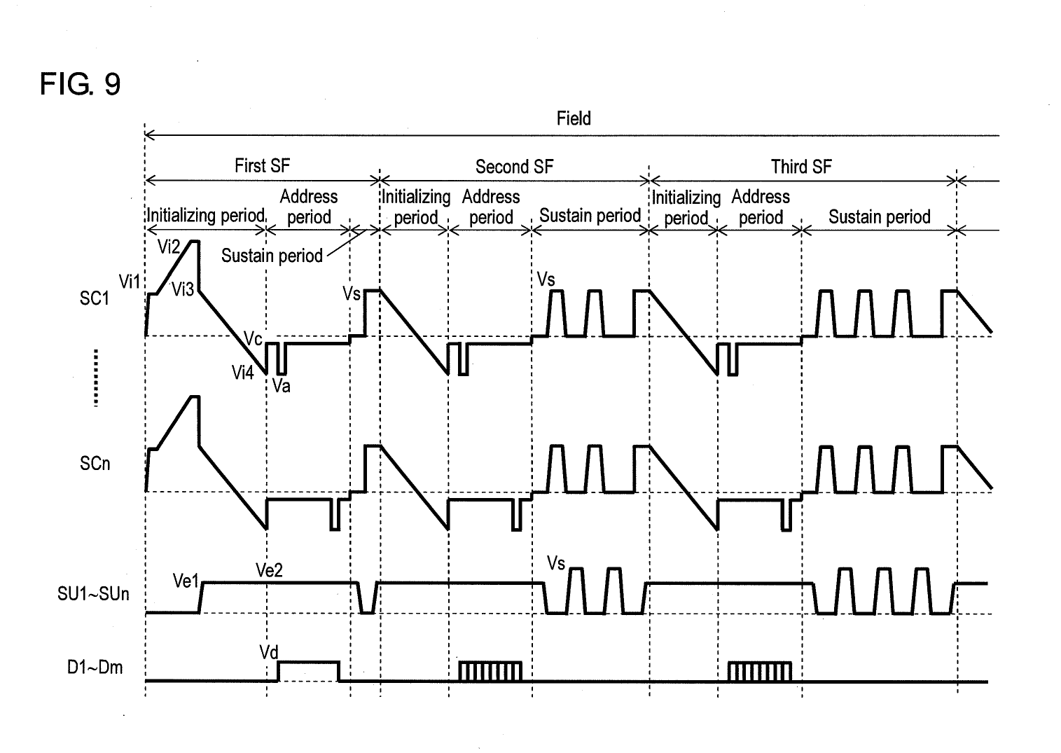

Next, surplus charge erasing operation, which is the feature of the present invention, is described. FIG. 9 is a waveform chart of driving voltages to be applied to the respective electrodes of panel 10 for surplus charge erasing operation in accordance with the exemplary embodiment of the present invention. In this waveform chart, the surplus charge erasing operation is performed in the first SF. In the exemplary embodiment, a subfield where the surplus charge erasing operation is performed is interposed at a rate of once every approximately 10 seconds (once every 600 fields), and the driving voltage waveforms of FIG. 9 are applied to the respective electrodes.

The operation in the initializing period of the first SF where the surplus charge erasing operation is performed is similar to the operation in the initializing period of the first SF where no surplus charge erasing operation is performed. Thus the description of that operation is omitted.

In the address period of the first SF where the surplus charge erasing operation is performed, voltage Vet is applied to sustain electrodes SU1 through SUn, and voltage Vc is applied to scan electrodes SC1 through SCn.

Next, negative scan pulse voltage Va is applied to scan electrode SC1 in the first line. Regardless of the image to be displayed, positive address pulse voltage Vd is applied to all data electrodes D1 through Dm. The voltage difference in the intersecting part between all data electrodes D1 through Dm and scan electrode SC1 is obtained by adding the difference in an externally applied voltage (Vd−Va) to the difference between the wall voltage on data electrodes D1 through Dm and the wall voltage on scan electrode SC1. Thus the voltage difference exceeds the discharge start voltage. Then, an address discharge occurs between all data electrodes D1 through Dm and scan electrode SC1, and between sustain electrode SU1 and scan electrode SC1. Positive wall voltage accumulates on scan electrode SC1 and negative wall voltage accumulates on sustain electrode SU1. Negative wall voltage also accumulates on data electrodes D1 through Dm.

In this manner, an address discharge is caused in all the discharge cells in the first line. The above address operation is repeated until the operation reaches the discharge cells in the n-th line, and the address period where the surplus charge erasing operation is performed is completed. The driving voltage waveform to be applied to data electrodes D1 through Dm of FIG. 9 is merely an example. Any driving voltage waveform may be used as long as the waveform causes an address discharge in all the discharge cells regardless of the image to be displayed.

In the subsequent sustain period, no sustain pulse is applied to scan electrodes SC1 through SCn and sustain electrodes SU1 through SUn, and a voltage difference in the form of a so-called narrow pulse is caused between scan electrodes SC1 through SCn and sustain electrodes SU1 through SUn. With this application, while positive wall voltage is left on data electrode Dk, the wall voltages on scan electrodes SC1 through SCn and sustain electrodes SU1 through SUn are erased. Here, instead of a potential difference in the form of a narrow pulse, a potential difference in a ramp waveform may be caused to erase the wall voltages on scan electrodes SC1 through SCn and sustain electrodes SU1 through SUn, while positive wall voltage is left on data electrode Dk.

The operations in the second SF through the 10th SF are similar to those in the second SF through the 10th SF of FIG. 8 because no surplus charge erasing operation is performed in these subfields.

As described above, in the exemplary embodiment, driving voltage waveforms of FIG. 8 are applied to the respective electrodes of panel 10 for image display. Further, the driving voltage waveforms of FIG. 9 are applied to the respective electrodes of panel 10 at a rate of once every approximately 10 seconds, for surplus charge erasing operation. In this manner, panel 10 is driven in a manner that a subfield where an address discharge is caused in all the discharge cells in the address period is interposed at predetermined time intervals. Thus panel 10 having high luminance and high emission efficiency can be driven stably at high speed without any false discharge.

The reason for the above is described hereinafter. The false discharge caused by an all-cell initializing operation is likely to occur in a panel having a high xenon partial pressure when a dark image is displayed. The false discharge is likely to occur especially in an area displaying black for an extended period of time, i.e. an area of discharge cells where no discharge is caused for an extended period of time except a discharge caused by the all-cell initializing operation. A strong false discharge in a vertical stripe shape may occur at a rate of once every several tens seconds to several minutes.

Though not yet clarified completely, the cause of this false discharge can be considered as follows, for example. The discharge in the all-cell initializing operation is a discharge caused by a ramp waveform voltage gradually rising or falling, and is a weak discharge occurring locally in the vicinity of the discharge gaps between facing scan electrodes 22 and sustain electrodes 23. Thus the wall charge is relocated in the vicinity of the discharge gaps in the discharge cells, so that the wall voltages are controlled. However, the wall charge in the portions far from the discharge gaps cannot be erased by the discharge caused by the all-cell initializing operation. Then, unnecessary charge accumulates in the portions far from the discharge gaps, as surplus charge, as time elapses. When this accumulated surplus charge exceeds a predetermined limit value, the surplus charge discharges at a burst and causes a false discharge.

In the exemplary embodiment, an address discharge is caused between all data electrodes D1 through Dm and scan electrode SC1, and between sustain electrode SU1 and scan electrode SC1, at a rate of once every approximately 10 seconds, so that the surplus charge in the discharge cells are erased. Therefore, even if a certain level of surplus charge accumulates, the accumulated charge is erased before exceeding the limit value, thus causing no false discharge. Further, the discharge for erasing the surplus charge is caused regardless of image display. Thus, in order to minimize the luminance at this time, the wall voltages on scan electrodes SC1 through SCn and sustain electrodes SU1 through SUn are erased without application of any sustain pulse in the sustain period of the first SF where the surplus charge erasing operation is performed.

In the description of the exemplary embodiment, a subfield where the surplus charge erasing operation is performed is interposed at a rate of once every approximately 10 seconds. However, it is preferable that the frequency at which the subfield for the surplus charge erasing operation is interposed is set optimum for the discharge characteristics of the panel, or the like.

In the description of the exemplary embodiment, the subfield where the surplus charge erasing operation is performed is the first SF. However, the surplus charge erasing operation may be performed in the other subfields. However, in order to prevent degradation of the image display quality, it is preferable to perform the surplus charge erasing operation in a subfield having a smaller number of sustain pulses.

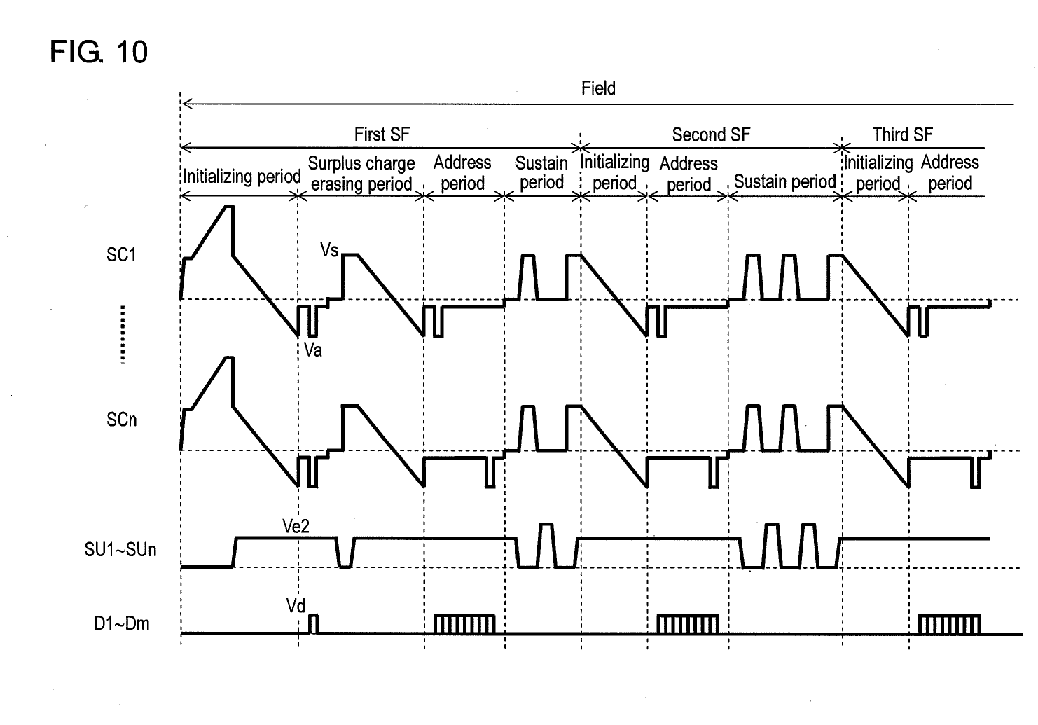

In this exemplary embodiment, the operation for erasing surplus charge is performed in the whole period of one subfield (the first SF). However, the surplus charge may be erased by interposing a period for the surplus charge erasing operation (hereinafter simply referred to as “surplus charge erasing period”) in any one of the subfields. FIG. 10 is a waveform chart of driving voltages to be applied to the respective electrodes of panel 10 for surplus charge erasing operation in accordance with another exemplary embodiment of the present invention. FIG. 10 shows driving voltage waveforms where the surplus charge erasing period is interposed before the address period of the first SF.

The operation in the initializing period of the first SF that has the surplus charge erasing period is similar to the operation in the initializing period of the first SF that has no surplus charge erasing period. Thus the description of that operation is omitted.

In the subsequent surplus charge erasing period, voltage Vet is applied to sustain electrodes SU1 through SUn. Further, negative scan pulse voltage Va is applied to all scan electrodes SC1 through SCn, and positive address pulse voltage Vd is applied to all data electrodes D1 through Dm. Then, an address discharge for erasing surplus charge occurs in all the discharge cells. Thus positive wall voltage accumulates on scan electrodes SC1 through SCn, and negative wall voltage accumulates on sustain electrodes SU1 through SCn. Negative wall voltage also accumulates on data electrodes D1 through Dm.

Thereafter, a voltage difference in the form of a so-called narrow pulse is caused between scan electrodes SC1 through SCn and sustain electrodes SU1 through SUn. With this application, while positive wall voltage is left on data electrode Dk, the wall voltages on scan electrodes SC1 through SCn and sustain electrodes SU1 through SUn are erased. Here, instead of a potential difference in the form of a narrow pulse, a potential difference in a ramp waveform may be caused to erase the wall voltages on scan electrodes SC1 through SCn and sustain electrodes SU1 through SUn, while positive wall voltage is left on data electrode Dk.

The operations of the address period of the first SF and thereafter are similar to those of the address period of the first SF and thereafter that have no surplus charge erasing period, and the description of those operations is omitted.

In the above descriptions, the surplus charge erasing period is interposed in the first SF. However, the present invention is not limited to this structure. The same advantage can be obtained when the surplus charge erasing period is interposed in the other subfields.

Next, a description is provided for an example of a panel driving circuit for driving the panel by generating the above driving voltages.

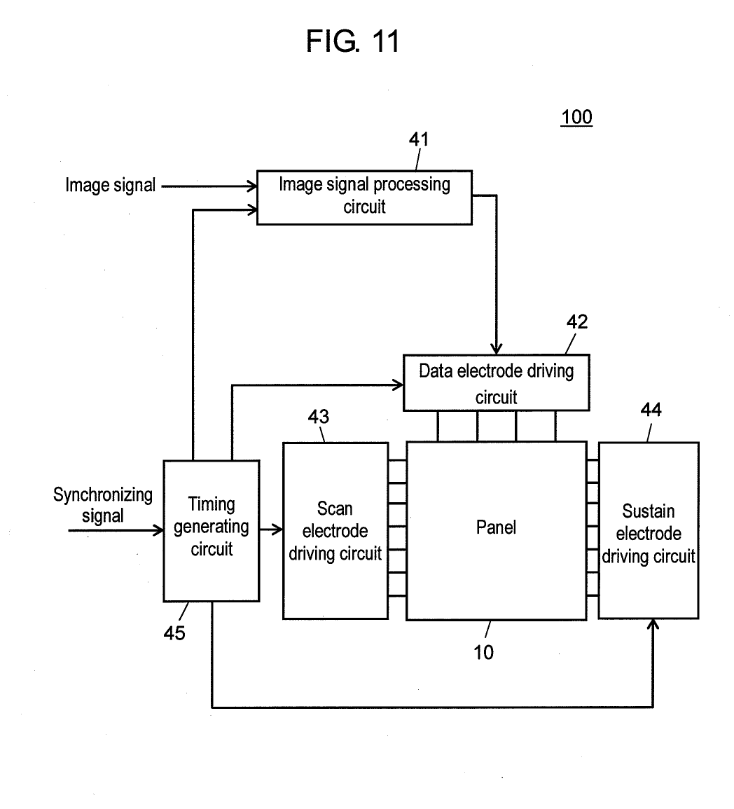

FIG. 11 is a circuit block diagram of plasma display device 100 in accordance with the exemplary embodiment of the present invention. Plasma display panel 100 has panel 10 and a panel driving circuit. The panel driving circuit has the following elements:

image signal processing circuit 41;

data electrode driving circuit 42;

scan electrode driving circuit 43;

sustain electrode driving circuit 44;

timing generating circuit 45; and

power supply circuits (not shown) for supplying power necessary for each circuit block.

Image signal processing circuit 41 converts input image signals into image data showing light emission and no light emission in each subfield. Data electrode driving circuit 42 converts the image data in each subfield into a signal corresponding to each of data electrodes D1 through Dm, and drives each of data electrodes D1 through Dm.

Timing generating circuit 45 generates various timing signals for controlling the operation of each circuit block in the following manner according to a horizontal synchronizing signal and a vertical synchronizing signal, and supplies the timing signals to each circuit block. The control is made so that either of the following subfields is interposed at predetermined time intervals. They are a subfield where an address discharge is caused in all the discharge cells in the address period, and a subfield where a period for causing an address discharge in all the discharge cells is interposed before the address period.

Scan electrode driving circuit 43 drives each of scan electrodes SC1 through SCn according to the timing signals. Sustain electrode driving circuit 44 drives sustain electrodes SU1 through SUn according to the timing signals.

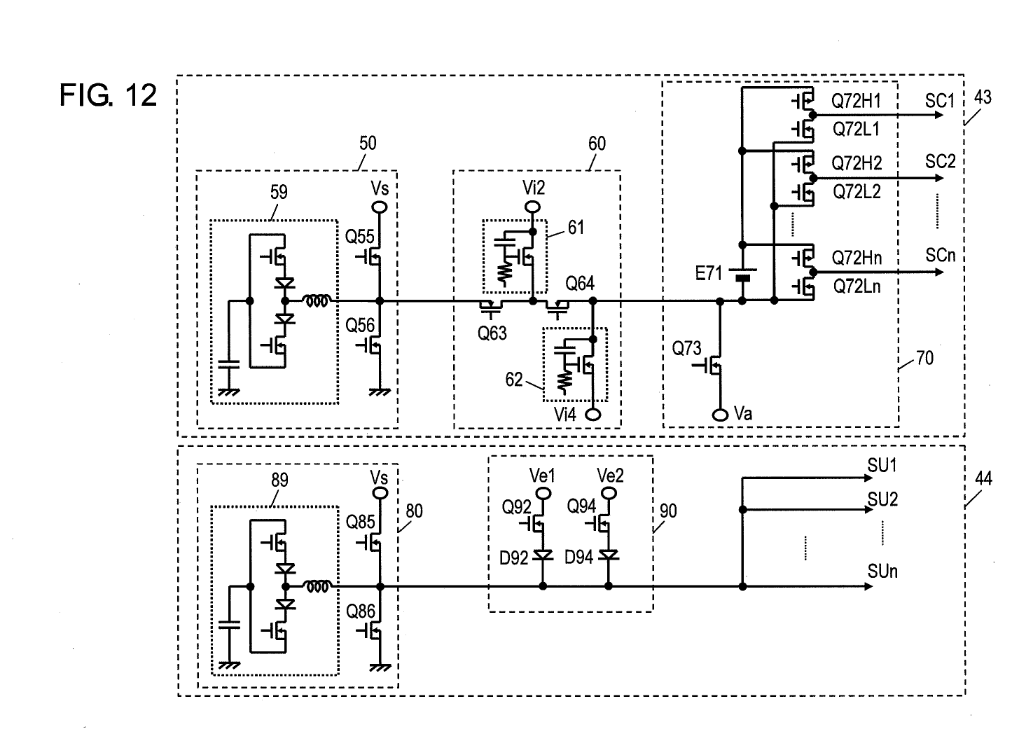

FIG. 12 is a circuit diagram of scan electrode driving circuit 43 and sustain electrode driving circuit 44 of plasma display device 100 in accordance with the exemplary embodiment of the present invention.

Scan electrode driving circuit 43 has sustain pulse generating circuit 50, initializing waveform generating circuit 60, and scan pulse generating circuit 70. Sustain pulse generating circuit 50 has the following elements:

switching element Q55 for applying voltage Vs to scan electrodes SC1 through SCn;

switching element Q56 for applying 0 (V) to scan electrodes SC1 through SCn; and

power recovering section 59 for recovering power when sustain pulses are applied to scan electrodes SC1 through SCn.

Initializing waveform generating circuit 60 has Miller integrating circuit 61 for applying an up-ramp waveform voltage to scan electrodes SC1 through SCn, and Miller integrating circuit 62 for applying a down-ramp waveform voltage to scan electrodes SC1 through SCn. Switching element Q63 and switching element Q64 are disposed to prevent backflow of current via parasitic diodes, for example, of other switching elements. Scan pulse generating circuit 70 has the following elements:

floating power supply E71;

switching elements Q72H1 through Q72Hn for applying the voltage at the high-voltage side of floating power supply E71 to scan electrodes SC1 through SCn;

switching elements Q72L1 through Q72Ln for applying the voltage at the low-voltage side of the floating power supply to the scan electrodes; and

switching element Q73 for fixing the voltage at the low-voltage side of floating power supply E71 to voltage Va.

Sustain electrode driving circuit 44 has sustain pulse generating circuit 80, and initializing/address voltage generating circuit 90. Sustain pulse generating circuit 80 has the following elements:

switching element Q85 for applying voltage Vs to sustain electrodes SU1 through SUn;

switching element Q86 for applying 0 (V) to sustain electrodes SU1 through SUn; and

power recovering section 89 for recovering power when sustain pulses are applied to sustain electrodes SU1 through SUn.

Initializing/address voltage generating circuit 90 has the following elements: switching element Q92 and diode D92 for applying voltage Ve1 to sustain electrodes SU1 through SUn; and

switching element Q94 and diode D94 for applying voltage Ve2 to sustain electrodes SU1 through SUn.

These switching elements can be configured of generally known devices, such as a metal oxide semiconductor field-effect transistor (MOSFET), and an insulated gate bipolar transistor (IGBT). These switching elements are controlled, according to timing signals that are generated in timing generating circuit 45 and correspond to the switching elements.

The driving circuit of FIG. 12 is an example of a circuit configuration for generating the driving voltage waveforms of FIG. 7. The plasma display device of the present invention is not limited to this circuit configuration.

The respective specific values for use in the exemplary embodiment are merely examples. It is preferable to set values optimum for the characteristics of the panel, the specifications of the plasma display device, or the like, for each case.

### INDUSTRIAL APPLICABILITY

The plasma display device of the present invention is capable of performing high-speed stable address operation, and displaying images of excellent display quality, and thus is useful as a display device.

1. A plasma display device comprising:
a plasma display panel including:
a front plate having display electrode pairs on a first glass substrate, a dielectric layer disposed so as to cover the display electrode pairs, and a protective layer disposed on the dielectric layer;
a back plate having data electrodes on a second glass substrate, the back plate facing the front plate; and
discharge cells formed in positions where the display electrode pairs face the data electrodes; and
a panel driving circuit for driving the plasma display panel in a manner that a plurality of subfields are temporally disposed to form one field period, each of the subfields having an initializing period for causing an initializing discharge, an address period for causing an address discharge, and a sustain period for causing a sustain discharge in the discharge cells,
wherein the panel driving circuit drives the plasma display panel in a manner that the subfields include a subfield where a period for causing an address discharge in all the discharge cells is disposed in the address period, or before the initializing period and the address period, and the subfield is interposed at predetermined time intervals.

2. The plasma display device of claim 1, wherein each of the predetermined time intervals is equal to or shorter than 10 seconds.

3. The plasma display device of claim 1, wherein, in the front plate of the plasma display panel, the protective layer has a base protective layer formed on the dielectric layer, and a particle layer formed on the base protective layer, and the particle layer is formed by attaching single-crystal particles of magnesium oxide.
